(19) United States
(12) Patent Application Publication
(10) Pub. No.: US 2004/0139219 A1
(43) Pub. Date: Jul. 15, 2004

(54) Transcaling: a video coding and multicasting framework for wireless IP multimedia services

(76) Inventor: Hayder Radha, East Lansing, MI (US)

Correspondence Address: HARNESS, DICKEY & PIERCE, P.L.C., P.O. BOX 828, BLOOMFIELD HILLS, MI, 48303, US

(21) Appl. No.: 10/751,373

(22) Filed: Jan. 5, 2004

Related U.S. Application Data
(63) Continuation of application No. PCT/US02/21102, filed on Jul. 2, 2002.
(60) Provisional application No. 60/303,165, filed on Jul. 5, 2001.

(51) Int. Cl. G06F 15/16

(52) U.S. Cl. 709/234; 709/247

(57) ABSTRACT

A network node (124) includes an input module operable to receive an original scalable bit stream (126) having an original bandwidth range, a transcaling module operable to generate a new scalable bit stream (128) having a new bandwidth range, wherein the new bandwidth range corresponds to a range of bandwidth that is different from that of the original bandwidth range, and an output module operable to transmit said new scalable bit stream (128) downstream.

### CROSS-REFERENCE TO RELATED APPLICATIONS

This application is a continuation of PCT/US02/21102, filed Jul. 2, 2002, which claims priority to provisional U.S. Patent Application No. 60/303,165 filed on Jul. 5, 2001. The disclosure of the above application is incorporated herein by reference.

### FIELD OF THE INVENTION

The present invention generally relates to transcoding and particularly relates to scalable bit streams.

### BACKGROUND OF THE INVENTION

The Internet exhibits a wide range of available bandwidth over both the core network and over different types of access technologies. New wireless Line Access Networks (LANs) and mobile networks have emerged as important Internet access mechanisms. Both the Internet and wireless networks continue to evolve to higher bit rate platforms with even larger amounts of possible variations in bandwidth and other Quality-of-Services parameters. For example, IEEE 802.11a and HiperLAN2 wireless LANs support (physical layer) bit rates from 6 Mbit/sec to 54 Mbit/sec. Within each of the supported bit rates, there are further variations in bandwidth due to the shared nature of the network and the heterogeneity of the devices and the quality of their physical connections. Moreover, wireless LANs are expected to provide higher bit rates than mobile networks (including 3rd generation).

Current wireless and mobile access networks (2G and 2.5G mobile systems and sub-2 Mbit/sec wireless LANs) are expected to coexist with new generation systems for sometime to come. All of these developments indicate that the level of heterogeneity and the corresponding variation in available bandwidth could be increasing significantly as the Internet and wireless networks converge more and more into the future. In particular, considering the Internet and different wireless/mobile access networks as a large multimedia heterogeneous system leads to an appreciation of the potential challenge in addressing the bandwidth variation over this system.

Many scalable video compression methods have been proposed and used extensively in addressing the bandwidth variation and heterogeneity aspects of the Internet and wireless networks. Examples of scalable video compression methods include Receiver-Driven Multicast (RDM) multilayer coding, MPEG-4 Fine-Granular-Scalable (FGS) Compression, and H.263 based scalable methods. These and other similar approaches usually generate a Base Layer (BL) and one or more Enhancement Layers (ELs) to cover the desired bandwidth range. Consequently, these approaches can be used for multimedia multicast services over wireless Internet Networks.

In general, the wider the bandwidth range that needs to be covered by a scalable video stream, the lower the overall video quality. This observation is particularly true for the scalable schemes that fall under the category of SNR (Signal-to-Noise Ratio) scalability methods. These methods include the MPEG-2 and MPEG-4 SNR scalability methods, as well as the MPEG-4 Fine-Granular-Scalability (FGS) method. With the aforementioned increase in heterogeneity over emerging wireless multimedia IP networks, there is a need for scalable video coding and distribution solutions that maintain good video quality while addressing the high-level of anticipated bandwidth variation over these networks. One trivial solution is the generation of multiple streams that cover different bandwidth ranges. For example, a content provider, that is covering a major event, can generate one stream that covers 100-500 kbit/sec, another that covers 500-1000 kbit/sec and yet another stream to cover 1000-2000 Kbit/sec and so on. Although this solution may be viable under certain conditions, it is desirable from a content provider perspective to generate the fewest number of streams that covers the widest possible audience. Moreover, multicasting multiple scalable streams (each of which consists of multiple multicast sessions) is inefficient in terms of bandwidth utilization over the wired segment of the wireless IP network. (In the above example, a total bit rate of 3500 kbit/sec is needed over a link transmitting the three streams while only 2000 kbit/sec of bandwidth is needed by a scalable stream that covers the same bandwidth range.)

The need remains, therefore, for a solution to the problems associated with maintaining good video quality that addresses the high-level of anticipated bandwidth variation over networks. The present invention provides such a solution.

### SUMMARY OF THE INVENTION

In a first aspect, the present invention is a network node including an input module operable to receive an original scalable bit stream having an original bandwidth range, a transcaling module operable to generate a new scalable bit stream having a new bandwidth range, wherein the new bandwidth range corresponds to a range of bandwidth that is different from that of the original bandwidth range, and an output module operable to transmit said new scalable bit stream downstream.

In a second aspect, the present invention is a propagating wave for transmission of a new scalable bit stream. The wave includes a base layer and a plurality of new enhancement layers covering a new bandwidth range, wherein the new bandwidth range has a new minimum bit rate compared to an original minimum bit rate of an original bandwidth range of a plurality of original enhancement layers of an original scalable bit stream upon which the new bit stream is based.

In a third aspect, the present invention is a transcaling system, including an input module operable to receive an original scalable bit stream having an original bandwidth range, a decoder operable to decode at least a portion of the original bit stream, and an encoder operable generate a new scalable bit stream by encoding a decoded portion of the original scalable bit stream.

In a fourth aspect, the present invention is a transcaling method including receiving an original scalable bit stream having an original minimum bit rate over a communications network, determining a new minimum bit rate, and generating a new scalable bit stream based on the original scalable bit stream and the determined new minimum bit rate.

The present invention is advantageous over previous streaming unicast, multicast, and/or broadcast systems because new higher-bandwidth LANs do not have to scarify in video quality due to coexistence with legacy wireless LANs, other low-bit rate mobile networks, and/or low-bit rate wire networks. Similarly, powerful clients (laptops and Personal Computers) can still receive high quality video even if there are other low-bit rate low-power devices that are being served by the same wireless/mobile network. Moreover, when combined with embedded video coding schemes and the basic tools of RDM, transcaling provides an efficient framework for video multicast over the wireless Internet. Finally, hierarchical Transcaling (HTS) provides a “Transcalar” the option of choosing among different levels of transcaling processes with different complexities.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial-perspective block diagram depicting RDM as known in the art;

FIG. 2 is a block diagram depicting enhancement and base layers of the MPEG-4 FGS framework at different points in the multicasting process as known in the art;

FIG. 3 is a block diagram depicting Receiver-Driven Multicast to various clients from a streaming server as known in the art;

FIG. 4A is a diagrammatic and perspective view of a transcaling-based multicast at an edge node of a communications network according to the present invention;

FIG. 4B is a block diagram of transcaling-based multicast at an edge node of a communications network according to the present invention;

FIG. 5 is a graph depicting change in bandwidth range according to the present invention;

FIG. 6 is a block diagram depicting enhancement and base layers of the MPEG-4 FGS framework according to the hierarchical transcaling-based process of the present invention;

FIG. 7 is a block diagram depicting a full transcaling process according to the present invention;

FIG. 8 is a graph depicting increase in signal to noise resulting from a full transcaling process according to the present invention;

FIG. 9 is a graph depicting a comparison of a fully transcaled signal with an ideal signal according to the present invention;

FIG. 10 is a graph depicting performance of full transcaling according to the present invention with an increased requirement for range of bandwidth compared to FIG. 9;

FIG. 11 is a graph depicting performance of full transcaling the “Coastguard” MPEG-4 test sequence according to the present invention;

FIG. 12 is a graph depicting a loss in signal quality resulting from Down Transcaling according to the present invention; and

FIG. 13 depicts a comparison of performance of Down Transcaling using the entire input stream (base plus enhancement) and the base-layer of the input stream.

### DETAILED DESCRIPTION OF THE PREFERRED EMBODIMENT

The following description of the preferred embodiment is merely exemplary in nature and is in no way intended to limit the invention, its application, or uses.

The present invention is described below in the context of RDM in general, with particular examples involving the MPEG-4 FGS video coding standard. For this reason, RDM and the MPEG-4 FGS video coding standard are described below. It will be readily apparent to one skilled in the art, however, that the present invention may be extended to other coding and networking standards and methods in various contexts.

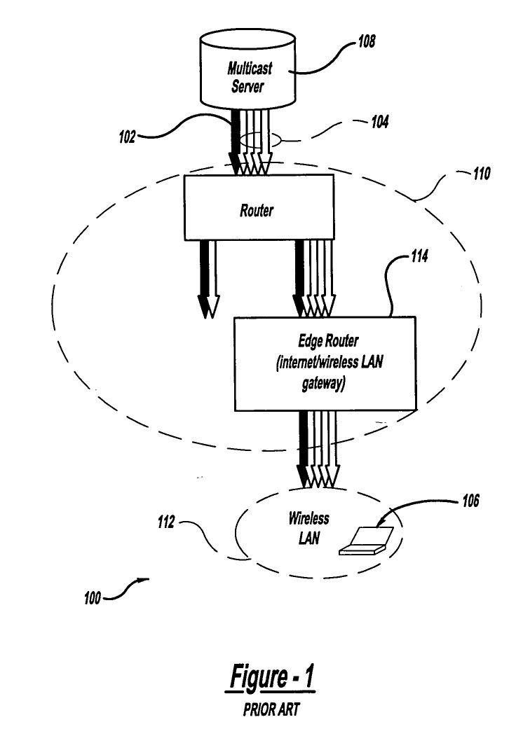

FIG. 1 shows an example of a scalable video compression method with the basic characteristics of the RDM framework 100. RDM of video is based on generating a layered, coded video bit stream that consists of multiple streams. The minimum quality stream is the BL 102 and the other streams are the ELs 104. These multiple video streams are mapped into a corresponding number of “multicast sessions”. A receiver 106 can subscribe to one (the BL stream) or more (BL plus one or more ELs) of these multicast sessions depending on the receiver's 106 access bandwidth to the Internet. Receivers 106 can subscribe to more multicast sessions or “unsubscribe” to some of the sessions in response to changes in the available bandwidth over time. The “subscribe” and “unsubscribe” requests generated by the receivers 106 are forwarded upstream toward the multicast server 108 by the different multicast enabled routers 110 between the receivers 106 and the multicast server 108. This approach results in an efficient distribution of video by utilizing minimal bandwidth resources over the multicast tree. The overall RDM framework 100 can also be used for receivers 106 that correspond to wireless IP devices of a wireless LAN 112 that are capable of decoding the scalable content transmitted by an IP multicast server 108 via a wireless LAN gateway 114.

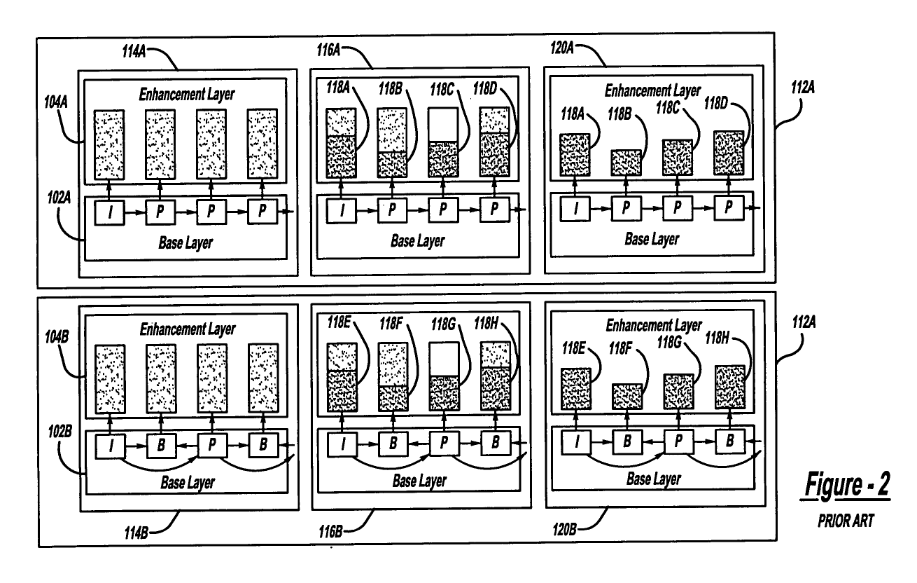

Another example of a scalable video compression method employs an MPEG-4 FGS video coding method that has been developed to meet the bandwidth variation requirements of the Internet and wireless networks. FGS encoding is designed to cover any desired bandwidth range while maintaining a very simple scalability structure. With reference to FIG. 2, the FGS structure 112A and 112B (with B frames) consists of only two layers: a base-layer 102A and 102B coded at a bit rate R_{b} and a single enhancement-layer 104A and 104B coded using a fine-grained (or totally embedded) scheme to a maximum bit rate of Rₑ.

This structure 112A and 112B provides a very efficient, yet simple, level of abstraction between the encoding and streaming processes. The encoder as at 114A and 114B only needs to know the range of bandwidth [Rₘᵢₙ=R_{b},Rₘₐₓ=Rₑ] over which it has to code the content, and it does not need to be aware of the particular bit rate at which the content will be streamed. The streaming server as at 116A and 116B on the other hand has a total flexibility in sending any desired portion 118A-118H of any enhancement layer frame (in parallel with the corresponding BL picture), without the need for performing complicated real-time rate control algorithms. This ease of operation enables the server to handle a very large number of unicast streaming sessions and to adapt to their bandwidth variations in real-time. On the receiver side, the FGS framework adds a small amount of complexity and memory requirements to any standard motion-compensation based video decoder as at 120A and 120B.

As shown in FIG. 2 and especially at 114A and 114B, the MPEG-4 FGS framework employs two encoders: one for the base-layer 102A and 102B and the other for the enhancement layer 104A and 104B. The base-layer 102A and 102B is coded with the MPEG-4 motion-compensation DCT-based video encoding method (non-scalable). The enhancement-layer 104A and 104B is coded using bitplane-based embedded DCT coding.

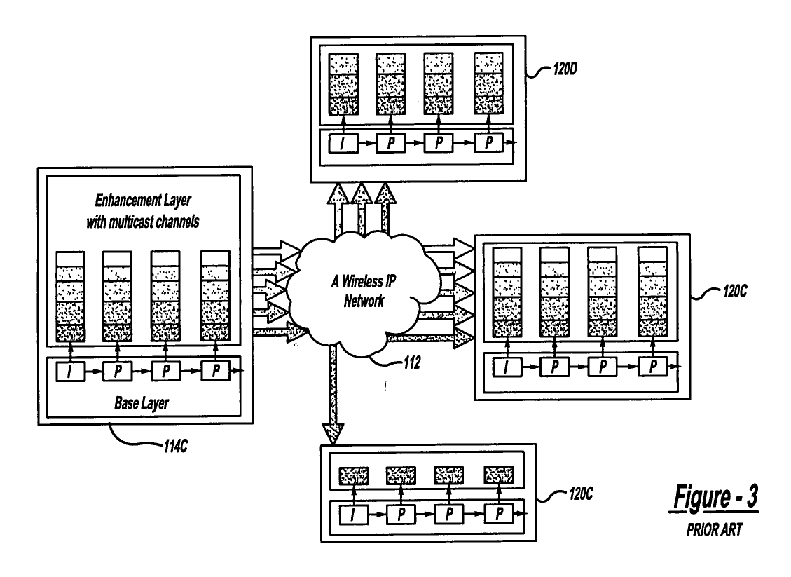

For RDM applications, FGS provides a flexible framework for the encoding, streaming, and decoding processes. Identical to the unicast case, the encoder compresses the content using any desired range of bandwidth [Rₘᵢₙ=R_{b}, Rₘₐₓ=Rₑ]. Therefore, the same compressed streams can be used for both unicast and multicast applications. At the time of transmission, the multicast server, as at 114C of FIG. 3, partitions the FGS enhancement layer into any preferred number of “multicast channels” each of which can occupy any desired portion of the total bandwidth. At the decoder side, as at 120D-120E, the receiver can “subscribe” to the “base-layer channel” and to any number of FGS enhancement-layer channels that the receiver is capable of accessing (depending for example on the receiver access bandwidth). It is important to note that regardless of the number of FGS enhancement-layer channels that the receiver subscribes to, the decoder has to decode only a single enhancement-layer. The above advantages of the FGS framework are achieved while maintaining good coding-efficiency results. However, similar to other scalable coding schemes, FGS over all performance can degrade as the bandwidth range that an FGS stream covers increases.

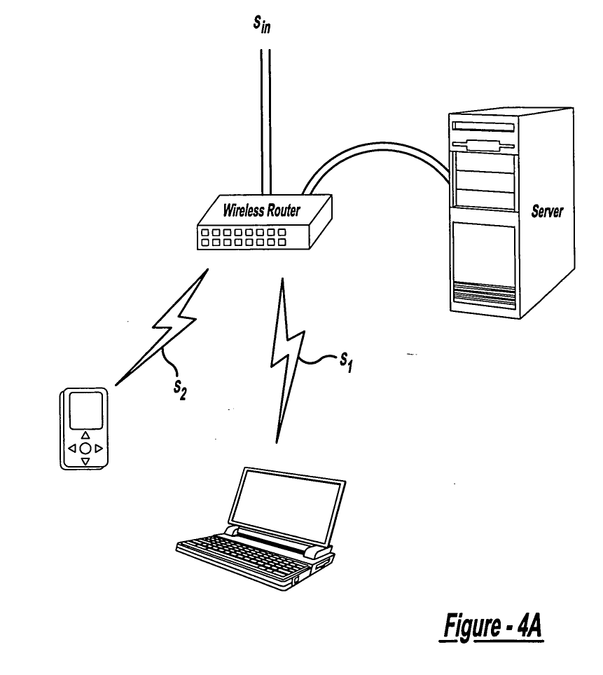

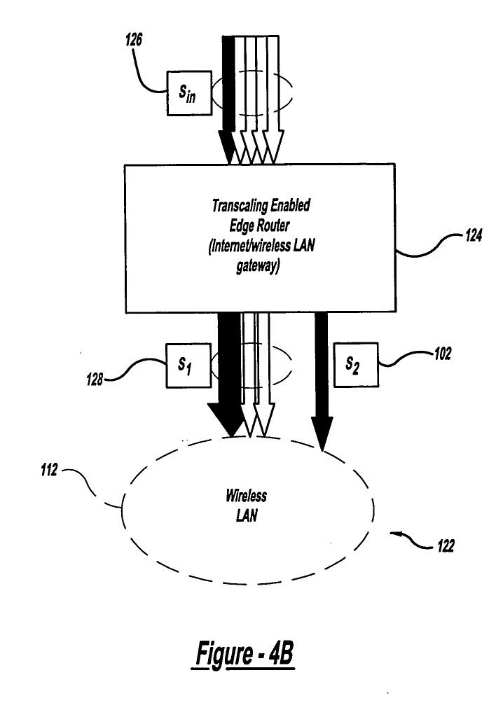

With reference to FIG. 4A, Transcaling-based Multicast (TSM) is similar to RDM in that it is driven by the receivers' 123A and 123B available bandwidth and their corresponding requests for viewing scalable video content. However, there is a fundamental difference between the TSM framework according to the present invention and traditional RDM. Under TSM, a network node 124 with a transcaling capability (or a “transcalar”) derives new scalable streams S₁, and S₂ from the original stream Sᵢₙ. The network node 124 corresponds in this exemplary case to an edge router as edge routers make good candidate locations in a network for transcaling to take place. The “Transcaling” process does not necessarily take place in the edge router itself but rather in a proxy server 125 (or a gateway) that is adjunct to the router and a part of the network node 124. A derived scalable stream could have a BL and/or enhancement-layer(s) that are different from the BL and/or ELs of the original scalable stream. The objective of the transcaling process is to improve the overall video quality by taking advantage of reduced uncertainties in the bandwidth variation at the edge nodes of the multicast tree.

For a wireless Internet multimedia service, an ideal location where transcaling can take place is at a gateway between the wired Internet and the wireless segment of the end-to-end network. FIG. 4B shows an example of a TSM system 122 where a gateway node 124 receives a layered-video stream 126, wherein a “layered” or “scalable” stream consists of multiple sub-streams, with a BL bit rate R_{min—in}. The bit rate range covered by this layered set of streams is R_{range—in}=[R_{min—in}, R_{max—in}]. The gateway node 124 transcales the input layered stream 126 Sᵢₙ into another scalable stream 128 S₁. This new stream 128 serves, for example, relatively high-bandwidth devices (such as laptops or Personal Computers) over the wireless LAN 112. The new stream 128 S₁ has a base-layer with a bit rate R_{min—1}>R_{min—in}. Consequently, in this example, the transcalar requires at least one additional piece of information and that is the minimum bit rate R_{min—1} needed to generate the new scalable video stream. This information can be determined based on analyzing the wireless links of the different devices connected to the network. By interacting with the access-point, the gateway server can determine the band-width range needed for serving its devices efficiently. This approach can improve the video quality delivered to higher-bit rate devices significantly.

Supporting transcaling at edge nodes (wireless LANs' and mobile networks' gateways) preserves the ability of the local networks to serve low-bandwidth low-power devices (such as handheld devices). In this example, in addition to generating the scalable stream 128 S₁ (which has BL bit rate that is higher than the bit rate of the input BL stream), the transcalar delivers the original BL stream 102 S₂ to the low-bit rate devices.

The proposed TSM system falls under the umbrella of active networks. In this case, the transcalar provides network-based added value services. The area of active networks covers many aspects, and “added value services” is just one of these aspects. Therefore, TSM can be viewed as a generalization of some recent work on active based networks with (non-scalable) video transcoding capabilities of MPEG streams.

Under the TSM system according to the present invention, a transcalar can always fallback to using the original (lower-quality) scalable video. This “fallback” feature represents a key attribute of transcaling that distinguishes it from non-scalable transcoding. The “fallback” feature could be needed, for example, when the Internet-wireless gateway (or whomever the transcalar happens to be) do not have enough processing power for performing the desired transcaling process(es). Therefore, and unlike (non-scalable) transcoding based services, transcaling provides a scalable framework for delivering higher quality video. A more graceful transcaling framework (in terms of computational complexity) is also feasible and is further described below.

Under a more general TSM framework, transcaling can take place at any node in the upstream path toward the multicast server. In fact, if the multicast server is covering a live event, then the scalable encoder system, which is compressing the video in real time, can generate the desired sets of scalable streams. This general view of TSM provides a framework for distributing and scaling the desired transcaling processes throughout the multicast tree. Moreover, this general TSM framework leads to some optimization alternatives for the system. For example, depending on the bit rate ranges determined by the different edge servers (such as wired/wireless/mobile gateway servers), the system have to trade off computational complexity (due to the transcaling processes) with bandwidth efficiency (due to the possible transmission of multiple scalable streams that have overlapping bit rate ranges over certain links).

The transcaling approach of the present invention, although primarily discussed in the context of multicast services, can also be used with on-demand unicast applications. For example, a wireless or mobile gateway may perform transcaling on a popular video clip that is anticipated to be viewed by many users on-demand. In this case, the gateway server has a better idea of the bandwidth variation that it (the server) has experienced in the past, and consequently it may generate the desired scalable stream through transcaling. This scalable stream can be stored locally for later viewing by the different devices served by the gateway.

Transcaling has its own limitations in improving the video quality over the whole desired bandwidth range. Nevertheless, the improvements that transcaling provides is significant enough to justify its merit over a subset of the desired bandwidth range. This aspect of transcaling will be explained further below.

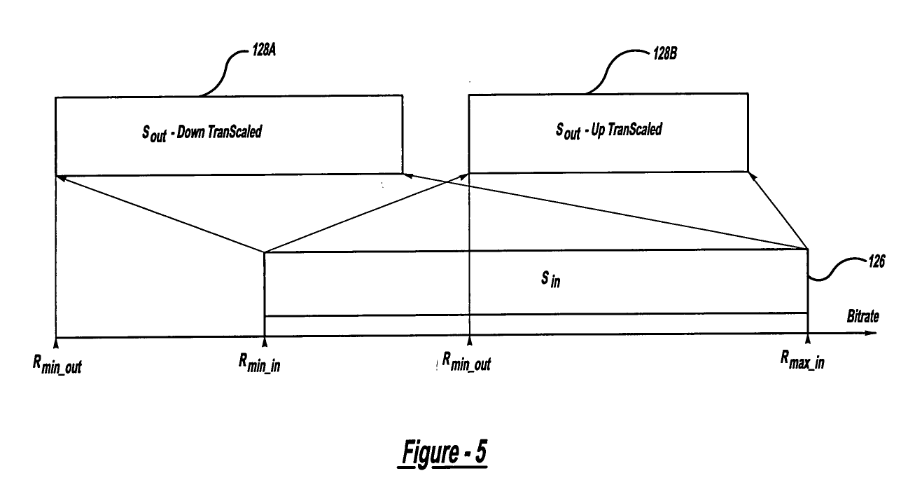

With reference to FIG. 5, there are two types of transcaling processes: Down Transcaling (DTS) as at 128A and Up Transcaling (UTS) as at 128B. Let the original input scalable stream Sᵢₙ as at 126 of a transcalar cover a bandwidth range:

R_{range—in}=[R_{min—in}, R_{max—in}].

and let a transcaled stream have a range:

R_{range—out}=[R_{min—out}, R_{max—out}].

Then, DTS occurs when: R_{min—out}<R_{min—in} while UTS occurs when: R_{min—in}<R_{min—out}<R_{max—in}. DTS as at 130 resembles traditional non-scalable transcoding in the sense that the bit rate of the output base-layer is lower than the bit rate of the input base-layer. This type of down conversion has been studied by many researchers in the past, but these efforts have not entailed down converting a scalable stream into another scalable stream. Moreover, up conversion as not received much attention (if any). Therefore, UTS and “transcaling” may be generally used interchangeably and will be so used hereafter.

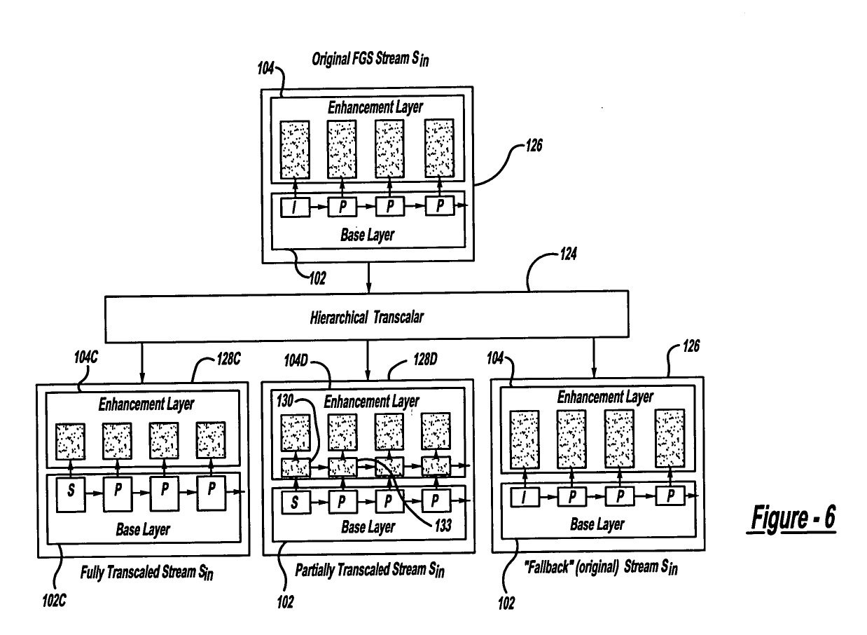

Examples of transcaling an MPEG-4 FGS stream are illustrated in FIG. 6. Under the first example, the input FGS stream 126 is transcaled into another scalable stream 128C S₁. In this case, the BL 102 BLᵢₙ of 128 Sᵢₙ (with bit rate R_{min—in}) and a certain portion of 104 ELᵢₙ are used to generate a new BL 102C BL₁. If Rₑ₁ represents the bit rate of the portion of the ELᵢₙ used to generate the new BL 102C BL₁, then this new BL's bit rate R_{min—1} satisfies the following:

R_{min—in}<R_{min—1}<R_{min—in}+Rₑ₁.

Consequently, and based on the definition adopted earlier for UTS and DTS, this example represents a UTS scenario. Furthermore, in this case, both the BL 104 and enhancement layer 102 of the input stream 126 Sᵢₙ has been modified. Consequently, this represents a “full” transcaling scenario. Full transcaling can be implemented using cascaded decoder-encoder systems. This implementation, in general could provide high quality improvements at the expense of computational complexity at the gateway server. Notably, one can reuse the motion vectors of the original FGS stream 126 Sᵢₙ to reduce the complexity of full transcaling. Reusing the same motion vectors, however, may not provide the best quality as has been shown in previous results for non-scalable transcoding.

The residual signal between the original stream 126 Sᵢₙ and the new BL₁ stream 102C is coded using FGS enhancement-layer compression to generate new enhancement layer 104C. Therefore, this is an example of transcaling an FGS stream 126 with a bit rate range R_{range—in}=[R_{min—in}, R_{max—in}] to another FGS stream 128C with a bit rate range R_{range—1}=[R_{min—1}, R_{max—1}]. It is important to note that the maximum bit rate R_{max—1} can be (and should be) selected to be smaller than the original maximum bit rate R_{max—in}:

R_{max—1}<R_{max—in}.

As further explained below, the quality of the new stream 128C R₁ at R_{max—1} may still be higher than the quality of the original stream 126 Sᵢₙ at a higher bit rate R>>R_{max—1}. Consequently, transcaling may enable a device which has a bandwidth R>>R_{max—1} to receive a better (or at least similar) quality video while saving some bandwidth. (This access bandwidth can be used, for example, for other auxiliary or non-realtime applications.) Further, it is feasible that the actual maximum bit rate of the transcaled stream 128C S₁ is higher than the maximum bit rate of the original input stream 126 Sᵢₙ. However, and as expected, this increase in bit rate does not provide any quality improvements. Consequently, it is important to truncate a transcaled stream 128C at a bit rate R_{max—1}<R_{max—in}.

As mentioned above under “full” transcaling, both the BL 102 and enhancement layer 104 of the original FGS stream 126 S₁, have been modified. Although the original motion vectors can be reused here, this process may still be computationally complex for some gateway servers. In this case, the gateway can always fallback to the original FGS stream 126B, and consequently, this option provides some level of computational scalability.

Furthermore, FGS provides another option for transcaling. Here, the gateway server can transcale the enhancement layer 104 only. This goal is achieved by (a) decoding a portion 130 of the enhancement layer 104 of one picture, and (b) using that decoded portion to predict the next picture 132 of the enhancement layer 104D, and so on. Therefore, in this case, the BL of the original FGS stream 102 Sᵢₙ is not modified and the computational complexity is reduced compared to full transcaling of the whole FGS stream (both BL and Els). Similar to the previous case, the motion vectors from the BL 102 can be reused here for prediction within the enhancement layer 104D to reduce the computational complexity significantly.

FIG. 6 shows the three options described above for supporting Hierarchical Transcaling (HTS) of FGS streams: full transcaling, partial transcaling, and the fallback (no transcaling) option. Depending on the processing power available to the gateway, the system can select one of these options. The transcaling process with the higher complexity provides bigger improvements in video quality.

It is important to note that within each of the above transcaling options, one can identify further alternatives to achieve more graceful transcaling in terms computational complexity. For example, under each option, one may perform the desired transcaling on a fewer number of frames. This represents some form of temporal transcaling.

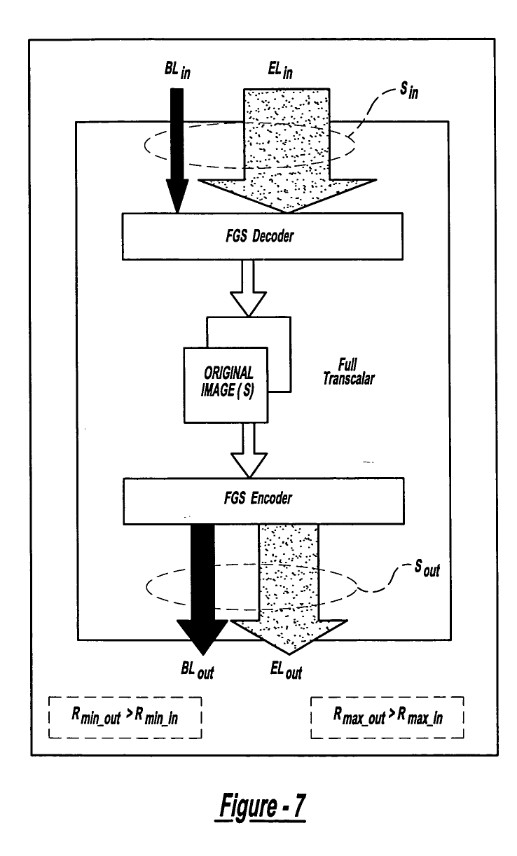

In order to illustrate the level of video quality improvements that transcaling can provide for wireless Internet multimedia applications, some simulation results of FGS based transcaling are presented. In arriving at the results presented below, several video sequences are coded using the draft standard of the MPEG-4 FGS encoding scheme. These sequences are then modified using the full transcalar architecture shown in FIG. 7. The main objective for adopting the transcalar shown in the figure is to illustrate the potential of video transcaling and highlight some of its key advantages and limitations. While it is clear that other elaborate algorithms can be used for performing transcaling, these elaborate algorithms could bias some of the findings regarding the performances of transcaling and related conclusions. Examples of these algorithms include

(a) refinement of motion vectors instead of a full re-computation of them; and

(b) transcaling in the compressed DCT domain.

The level of improvements achieved by transcaling depend on several factors. These factors include the type of video sequence that is being transcaled. For example, certain video sequences with a high degree of motion and scene changes are coded very efficiently with FGS. Consequently, these sequences may not benefit significantly from transcaling. On the other end, sequences that contain detailed textures and exhibit a high degree of correlation among successive frames could benefit from transcaling significantly. Overall, most sequences gain visible quality improvements from transcaling.

Another important factor is the range of bit rates used for both the input and output streams. Therefore, it is first necessary to decide on a reasonable set of bit rates that should be used in simulations. As mentioned in the introduction, newer wireless LANs (802.11a or HiperLAN2) may have bit rates on the order of tens of Mbits/second (more than 50 Mbit/sec). Although it is feasible that such high bit rates may be available to one or few devices at certain points in time, it is unreasonable to assume that a video sequence should be coded at such high bit rates. Moreover, in practice, most video sequences can be coded very efficiently at bit rates below 10 Mbits/sec. The exceptions to this statement are high-definition video sequences which could benefit from bit rates around 20 Mbit/sec. Consequently, the FGS sequences coded below were compressed at maximum bit rates (R_{max—in}) lower than 10 Mbits/sec. For the base-layer bit rate R_{min—in}, different values were used in the range of a few hundreds kbit/sec (between 200 and 500 kbit/sec.)

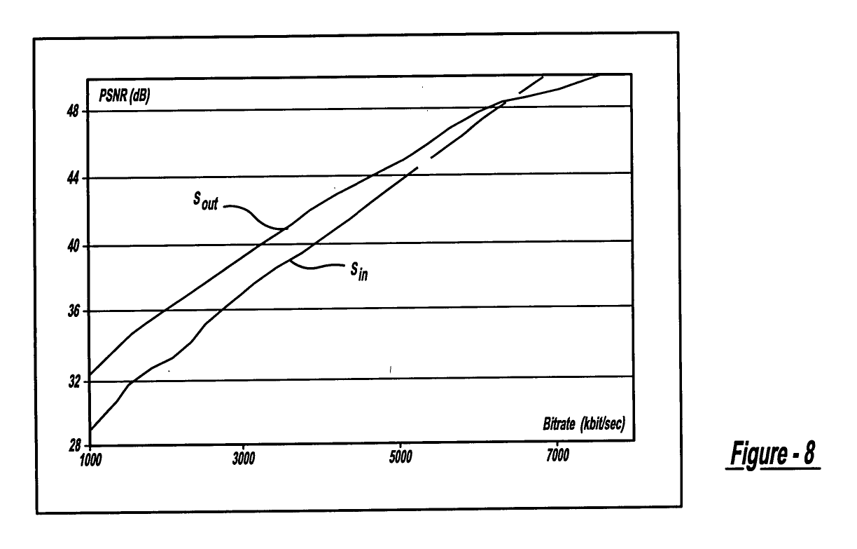

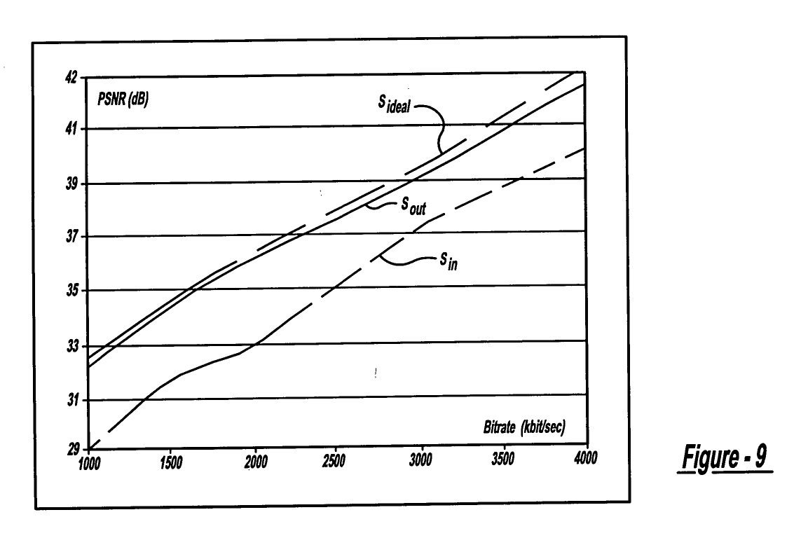

First, results are presented of transcaling an FGS stream that has been coded originally with R_{min—in}=250 kbit/sec and R_{max—in}=8 Mbit/sec. The transcalar uses a new base-layer bit rate R_{min—out}=1 Mbit/sec. The Peak SNG (PSNR) performance of the two streams as functions of the bit rate is shown in FIG. 8. It is clear from the figure that there is a significant improvement in quality (close to 4 dB) in particular at bit rates close to the new base-layer rate of 1 Mbit/sec. The figure also highlights that the improvements gained through transcaling are limited by the maximum performance of the input stream Sᵢₙ. As the bit rate gets closer to the maximum input bit rate (1 Mbit/sec), the performance of the transcaled stream saturates and gets close (and eventually degrades below) the performance of the original FGS stream Sᵢₙ. Nevertheless, for the majority of the desired bit rate range (above 1 Mbit/sec), the performance of the transcaled stream is significantly higher. In order to appreciate the improvements gained through transcaling, a comparison between the performance of the transcaled stream with that of an “ideal FGS” stream is made with reference to FIG. 9. Here, an “ideal FGS” stream is the one that has been generated from the original uncompressed sequence (not from a precompressed stream such as Sᵢₙ). In this example, an ideal FGS stream is generated from the original sequence with a base-layer of 1 Mbit/sec. FIG. 9 shows the comparison between the transcaled stream and an “ideal FGS stream over the range 1 to 4 Mbit/sec. As shown in the figure, the performances of the transcaled and ideal streams are virtually identical over this range.

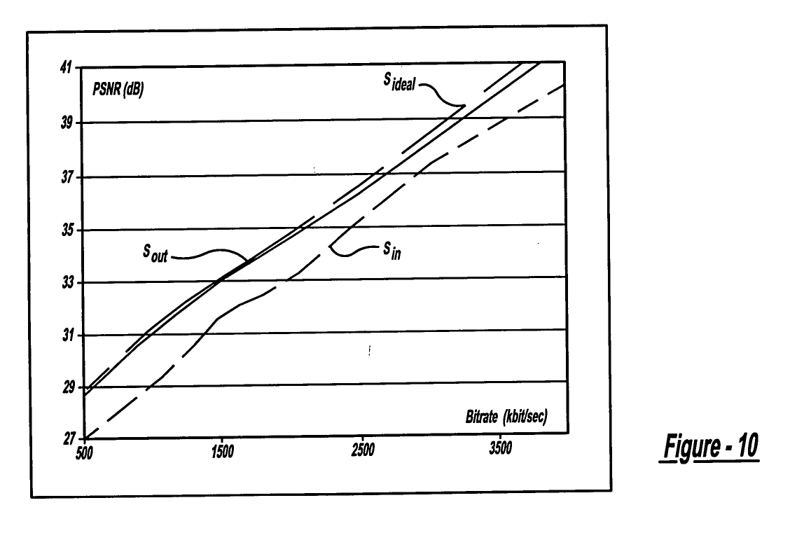

By increasing the range of bit rates that need to be covered by the transcaled stream, one would expect that its improvement in quality over the original FGS stream should get lower. Using the same original FGS (“Mobile”) stream coded with a base-layer bit rate of R_{min—in}=250 kbit/sec, this stream is transcaled with a new base-layer bit rate R_{min—out}=kbit/sec (lower than 1 Mbit/sec base-layer bit rate of the transcaling example described above). FIG. 10 shows the PSNR performance of the input, transcaled, and “ideal” streams. Here, the PSNR improvement is as high as 2 dB around the new base-layer bit rate 500 kbit/sec. These improvements are still significant (higher than 1 dB) for the majority of the bandwidth range. Similar to the previous example, the transcaled stream saturates toward the performance of the input stream Sᵢₙ at higher bit rates, and, overall, the performance of the transcaled stream is very close to the performance of the “ideal” FGS stream.

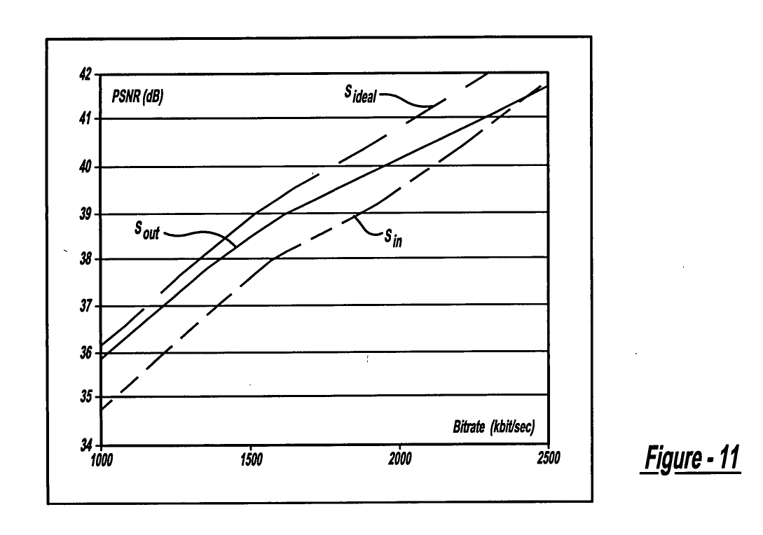

Therefore, transcaling provides rather significant improvements in video quality (around 1 dB and higher). The level of improvement is a function of the particular video sequences and the bit rate ranges of the input and output streams of the transcalar. For example, and as mentioned above, FGS provides different levels of performance depending on the type of video sequence. FIG. 11 illustrates the performance of transcaling the “Coastguard” MPEG-4 test sequence. The original MPEG-4 stream Sᵢₙ has a base-layer bit rate Rₘᵢₙ=250 kbit/sec and a maximum bit rate of 4 Mbit/sec. Overall, FGS (without transcaling) provides a better quality scalable video for this sequence when compared with the performance of the previous sequence (“Mobile”). Moreover, the maximum bit rate used here for the original FGS stream (R_{max—in}=4 Mbit/sec) is lower than the maximum bit rate used for the above “Mobile” sequence experiments. Both of these factors (a different sequence with a better FGS performance and a lower maximum bit rate for the original FGS stream Sᵢₙ) leads to the following conclusion: the level of improvements achieved in this case through transcaling is lower than the improvements observed for the “Mobile” sequence. Nevertheless, significant gain in quality (more than 1 dB at 1 Mbit/sec) can be noticed over a wide range over the transcaled bitstream. Moreover, the same “saturation-in-quality” behavior that characterized the previous “Mobile” sequence experiments is observable here. As the bit rate gets closer to the maximum rate R_{max—in,} the performance of the transcaled video approaches the performance of the original stream Sᵢₙ. The above results for transcaling are observable for a wide range of sequences and bit rates.

So far, the focus has been on the performance of UTS, which has been referred to above simply by using the word “transcaling”. Now, the focus shifts to some simulation results for DTS. As explained above, DTS can be used to convert a scalable stream with a base-layer bit rate R_{min—in} into another stream with a smaller base-layer bit rate R_{min—in} into another stream with a smaller BL bit rate R_{min—out}<R_{min—in}. This scenario could be needed, for example, if (a) the transcalar gateway misestimates the range of bandwidth that it requires for its clients, (b) a new client appears over the wireless LAN where this client has access bandwidth lower than the maximum bit rate (R_{min—in}) of the bitstream available to the transcalar; and/or (c) sudden local congestion over a wireless LAN is observed, and consequently reducing the minimum bit rate needed. In this case, the transcalar has to generate a new scalable bit-stream with a lower BL R_{min—out}<R_{min—in}. Some simulation results for DTS are shown below.

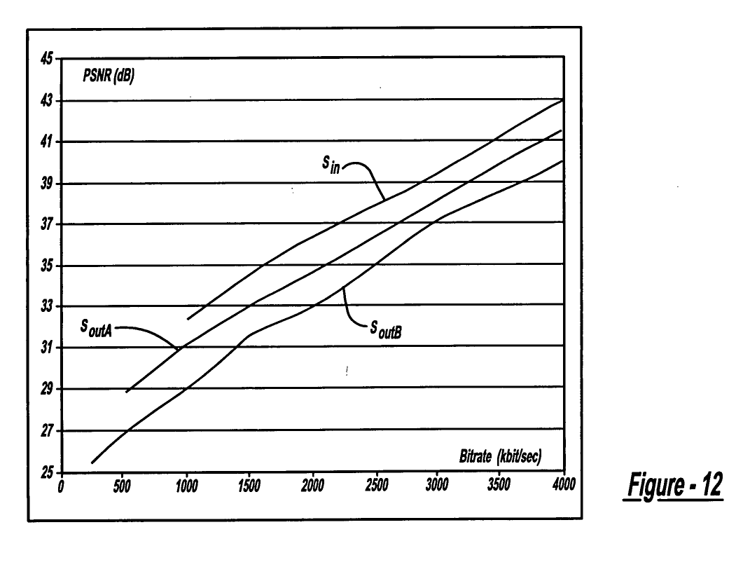

The same full transcalar architecture shown in FIG. 7 is employed in achieving the results below. The same “Mobile” sequence coded with MPEG-4 FGS and with a bit rate range R_{min—in}=1 Mbit/sec to R_{max—in}=8 Mbit/sec is also used. FIG. 12 illustrates the performance of the DTS operation for two bitstreams. One stream was generated by DTS the original FGS stream (with a base-layer of 1 Mbit/sec) into a new scalable stream S_{outA} coded with a base-layer of R_{min—out}=500 kbit/sec. The second stream S_{outB} was generated using a new BL R_{min—out}=250 kbit/sec. As expected, the DTS operation degrades the overall performance of the scalable stream.

It is important to note that, depending on the application (for example, unicase versus multicast), the gateway server may utilize both the new generated (down-transcaled) stream and the original scalable stream for its different clients. In particular, since the quality of the original scalable stream Sᵢₙ is higher than the quality of the down-transcaled stream Sₒᵤₜ over the range [R_{min—in}, R_{max—in}], then it should be clear that clients with access bandwidth that falls within this range can benefit from the higher quality (original) scalable stream Sᵢₙ. On the other hand, clients with access bandwidth less than the original base-layer bit rate R_{min—in}, can only use the down-transcaled bitstream.

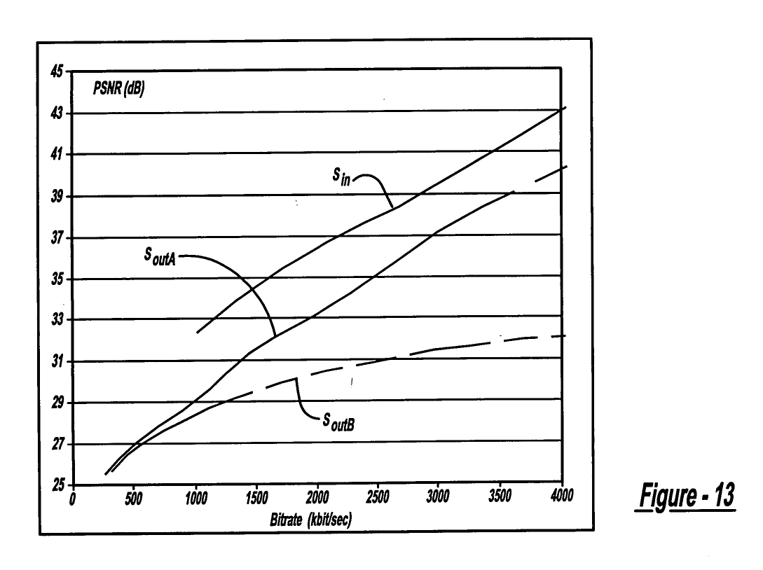

As mentioned above, DTS is similar to traditional transcoding which converts a non-scalable bitstream into another non-scalable stream with a lower bit rate. However, DTS provides new options for performing the desired conversion that are not available with non-scalable transcoding. For example, under DTS, one may elect to use (a) both the BL and ELs or (b) the BL only to perform the desired down-conversion. The second choice may be used, for example, to reduce the amount of processing power needed for the DTS operation. In this case, the transcalar has the option of performing only one decoding process (on the base-layer only versus decoding both the BL and ELs). However, using the base-layer only to generate a new scalable stream limits the range of bandwidth that can be covered by the new scalable stream with an acceptable quality. To clarify this point, FIG. 13 shows the performance of DTS using (a) the entire input stream Sᵢₙ (base plus enhancement) to produce S_{outA} and (b) the base-layer BLᵢₙ (only) of the input stream Sᵢₙ to produce S_{outB}. It is clear from the figure that the performance of the transcaled stream S_{outB} generated from BLᵢₙ saturates rather quickly and does not keep up with the performance of the other two streams. However, the performance of stream S_{outB} is virtually identical over most of the range [R_{min—out}=250 kbit/sec, R_{min—in}=500 kbit/sec]. Consequently, if the transcalar is capable of using both the original stream Sᵢₙ and the new up-transcaled stream Sₒᵤₜ for transmission to its clients, then employing the base-layer BLᵢₙ (only) to generate the new down-transcaled stream is a viable option.

It is important to note that, in cases when the transcalar needs to employ a single scalable stream to transmit its content to its clients (multicast with a limited total bandwidth constraint), a transcalar can use the base-layer and any portion of the enhancement layer to generate the new down-transcaled scalable bitstream. The larger the portion of the enhancement layer used for DTS, the higher the quality of the resulting scalable video. Therefore, and since partial decoding of the enhancement-layer represents some form of computational scalability, an FGS transcalar has the option of trading-off quality versus computational complexity when needed. It is important to note that this observation is applicable to both up-and DTS.

Finally, by examining FIG. 13, one can infer the performance of a wide range of down-transcaled scalable streams. The lower-bound quality of these downscaled streams is represented by the quality of the bitstream generated from the BL BLᵢₙ only, as with S_{outB}. Meanwhile, the upper-bound of the quality is represented by the downscaled stream S_{outA} generated by the full input stream Sᵢₙ.

It is important to note that the components and processes of the system and method of present invention vary according to the format of the original scalable bit stream and the process by which it was produced. The present invention has primarily been described in the context of video coding, and the MPEG-4 format in particular. Nevertheless, the present invention has equal application to other video coding and also audio coding applications. Thus, implementations of the present invention with FGS audio coding, Advanced Audio Coding (AAC), and other types of coding also apply. Further, while full and partial transcaling have been adequately detailed, variations in the processes may occur that fall within the scope of the invention. For example, although full transcaling herein described has entailed decoding the original stream to arrive at the original media, and then encoding the original media to obtain the new scalable stream, alternate coding procedures can produce the new fully transcaled stream from the original stream without having to reconstruct the original media. Further, multiple occurrences of partial transcaling may be applied to result in several new ELs and/or BLs. In general, the description of the invention is merely exemplary in nature and, thus, variations that do not depart from the gist of the invention are intended to be within the scope of the invention. Such variations are not to be regarded as a departure from the spirit and scope of the invention.

What is claimed is:

1. A network node comprising:
an input module operable to receive an original scalable bit stream having an original bandwidth range;
a transcaling module operable to generate a new scalable bit stream having a new bandwidth range, wherein the new bandwidth range corresponds to a range of bandwidth that is different from that of the original bandwidth range at least in that it has a new minimum bit rate that is different from an original minimum bit rate of the original bandwidth range; and
an output module operable to transmit said new scalable bit stream downstream.

2. The network node of claim 1, wherein said transcaling module comprises a decoder operable to decode at least a portion of the original scalable bit stream.

3. The network node of claim 2, wherein the original scalable bit stream has an original base layer and an original enhancement layer, and said decoder is operable to generate a first new enhancement layer and a second new enhancement layer by decoding a portion of the original enhancement layer, said transcaling module comprising a motion vector extraction module operable to extract motion vectors from the original base layer and operable to predict a next portion of said first new enhancement layer using the extracted original motion vectors.

4. The network node of claim 2, wherein the original scalable bit stream has an original base layer and an original enhancement layer, and said decoder is operable to generate a first new enhancement layer and a second new enhancement layer by decoding a portion of the original enhancement layer, said transcaling module comprising a motion vector generation module operable to predict a next portion of said first new enhancement layer by generating motion vectors for the first new enhancement layer.

5. The network node of claim 2, wherein the original scalable bit stream has a base layer and an enhancement layer, and said decoder is operable to reconstruct original media by decoding the base layer and the enhancement layer, the network node comprising an encoder operable to produce the new scalable bit stream by encoding the reconstructed media.

6. The network node of claim 1 comprising a processing power evaluation module operable to evaluate an amount of processing power available to said transcaling module.

7. The network node of claim 6, wherein said transcaling module is operable to generate the new scalable bit stream having the new bandwidth range based on the amount of available processing power.

8. The network node of claim 6, wherein said output module is operable to transmit the original scalable bit stream downstream if the amount available processing power is low.

9. The network node of claim 1 comprising a link evaluation module operable to evaluate bandwidth of links to downstream devices.

10. The network node of claim 1, wherein said transcaling module is operable to generate said new scalable bit stream having said new bandwidth range based on bandwidth of links to downstream devices.

11. The network node of claim 1, wherein said new bandwidth range is a reduced bandwidth range compared to the original bandwidth range.

12. The network node of claim 1, wherein said new minimum bit rate of said new bandwidth range is higher than said original minimum bit rate of said original bandwidth range.

13. The network node of claim 1, wherein said new minimum bit rate of said new bandwidth range is lower than said original minimum bit rate of said original bandwidth range.

14. The network node of claim 1, wherein a new maximum bit rate of said original scalable bit stream is lower than an original maximum bit rate of said original scalable bit stream.

15. The network node of claim 1, wherein said original scalable bit stream has an original base layer and an original enhancement layer, and said transcaling module is operable to generate a new base layer and a new enhancement layer based on said original base layer and said original enhancement layer.

16. The network node of claim 1, wherein said original scalable bit stream has an original enhancement layer, and said transcaling module is operable to decode a portion of said original enhancement layer for one picture and predict a next picture based on said decoded portion.

17. A propagating wave for transmission of a new scalable bit stream comprising:
a base layer; and
a plurality of new enhancement layers covering a new bandwidth range, wherein said new bandwidth range has a new minimum bit rate compared to an original minimum bit rate of an original bandwidth range of a plurality of original enhancement layers of an original scalable bit stream upon which said new bit stream is based.

18. The propagating wave of claim 15, wherein said new bandwidth range is further defined as a reduced bandwidth range.

19. The propagating wave of claim 15, wherein said new minimum bit rate is further defined as a higher bit rate than said original minimum bit rate.

20. The propagating wave of claim 15, wherein said base layer is further defined as a new base layer constructed from said original base layer and said plurality of original enhancement layers.

21. The propagating wave of claim 15, wherein said base layer is further defined as the original base layer, and wherein said new enhancement layers comprise a partially decoded portion of said plurality of original enhancement layers for a picture and a predicted next picture based on said decoded portion.

22. A transcaling system, comprising:
an input module operable to receive an original scalable bit stream having an original bandwidth range;
a decoder operable to decode at least a portion of the original bit stream; and
an encoder operable generate a new scalable bit stream by encoding a decoded portion of the original scalable bit stream.

23. The system of claim 20, comprising an output module operable to communicate the new scalable bit stream to a device.

24. The system of claim 21, wherein said output module is operable to communicate a base layer of the original scalable bit stream to the device if a bandwidth of a link to the device is low.

25. the system of claim 21, wherein said output module is operable to communicate said original scalable bit stream to the device if an amount of processing power available to said encoder and decoder is low.

26. The system of claim 20, comprising a processing power evaluation module operable to determine an amount of processing power available to said encoder and said decoder.

27. The system of claim 24, wherein said decoder is operable to decode the original scalable bit stream based on the amount of available processing power.

28. The system of claim 24, wherein said encoder is operable to encode the new scalable bit stream based on the amount of available processing power.

29. The system of claim 20, wherein said new bandwidth range is further defined as a reduced bandwidth range.

30. The system of claim 20, wherein said new bandwidth range is based on analysis of a communications link with said device.

31. The system of claim 20, wherein said transcaling module is further operable to generate said new scalable bit stream based on processing power available to said transcalar.

32. The system of claim 20, wherein a new minimum bit rate of said new bandwidth range is higher than an original minimum bit rate of said original scalable bit stream.

33. The system of claim 20, wherein said original scalable bit stream has an original base layer and an original enhancement layer, said decoder is operable to reconstruct original media from said original base layer and original enhancement layer, and said encoder is operable to generate a new base layer and a new enhancement layer based on said reconstructed media.

34. The system of claim 20, wherein said original scalable bit stream has an original enhancement layer, said decoder is operable to decode a portion of said original enhancement layer, and said encoder is operable to predict a next portion based on said decoded portion.

35. The system of claim 32, wherein the original scalable bit stream has a base layer, and wherein said encoder is operable to use motion vectors of said original base layer to predict the next portion.

36. A transcaling method comprising:
receiving an original scalable bit stream having an original minimum bit rate over a communications network;
determining a new minimum bit rate; and
generating a new scalable bit stream based on the original scalable bit stream and the determined new minimum bit rate.

37. The method of claim 34, wherein said receiving an original scalable bit stream comprises receiving an original scalable bit stream having an original base layer and an original enhancement layer.

38. The method of claim 35, wherein said generating a new scalable bit stream comprises generating a new base layer and a new enhancement layer based on said original base layer and said original enhancement layer.

39. The method of claim 35, wherein said generating a new scalable bit stream comprises:
decoding a portion of said original enhancement layer for one picture; and
predicting a next picture based on said decoded portion.

40. The method of claim 34 further comprising analyzing links of devices connected to said communications network, wherein said determining a new minimum bit rate is further based on said analyzed links.

41. The method of claim 34, wherein said determining a new minimum bit rate comprises determining a new minimum bit rate that is higher than said original minimum bit rate, and wherein said generating a new scalable bit stream comprises generating a new scalable bit stream having the new minimum bit rate.

42. The method of claim 34, wherein said determining a new minimum bit rate comprises determining a new minimum bit rate that is lower than said original minimum bit rate, and wherein said generating a new scalable bit stream comprises generating a new scalable bit stream having the new minimum bit rate.
